(19) United States
(12) Patent Application Publication
(10) Pub. No.: US 2011/0107047 A1
(43) Pub. Date: May 5, 2011

(54) Enforcing a File Protection Policy by a Storage Device

(76) Inventors: Rotem Sela, Haifa (IL); Michael Holtzman, Kfar Vradim (IL); Avraham Shmuel, Cupertino, CA (US)

(21) Appl. No.: 12/775,956

(22) Filed: May 7, 2010

Related U.S. Application Data
(60) Provisional application No. 61/257,673, filed on Nov. 3, 2009.

(51) Int. Cl. G06F 12/14; G06F 17/30

(52) U.S. Cl. 711/163; 707/828; 707/E17.01; 711/E12.091

(57) ABSTRACT

A file attribute, which is called herein “enforcement bit”, is used for each file that is stored in a storage device. If the protection particulars associated with a stored file are allowed to be changed, the enforcement bit is set to a first value, and if the protection particulars or properties are not to be changed, the enforcement bit is set to a second value. When the storage device is connected to a host device, the storage device provides to the host device protection particulars and an enforcement bit, which collectively form a “file protection policy”, for each stored file in response to a file system read command that the host device issues, in order to notify the host device of files in the storage device whose protection particulars are allowed to be changed freely, and of files whose protection particulars are not allowed to be changed by unauthorized users or devices.

### FIELD OF THE INVENTION

The present invention generally relates to storage devices and more specifically to a method for enforcing a file protection policy on a file stored in such devices, and to devices that use the file protection policy enforcing method.

### BACKGROUND

A computer file may be stored in a storage device with an associated file protection policy that defines ways for using, accessing or consuming the file. A file protection policy may, for example, protect specific memory blocks that hold parts of a file that has to be protected. In another example, a file protection policy, which is defined by setting file properties called “file attributes” to specific values, defines ways for using, accessing, or consuming files. Some file attributes, which are user-selectable, give users a basic protection means to protect files from specific storage operations (e.g., “read/write”). A user-selectable file attribute allows a user to switch between enabling and disabling protection of an associated file. The type of the protection rendered to a file is defined by the file attribute specifics. For example, if a file attribute called “read-only” is selected by the user (e.g., by checking or clicking it), a host device operating with a storage device that stores the file allows users to read the file but not to delete, change or overwrite it. Another user-selectable file attribute called “hidden”, if selected by the user, hides the file from (other) users. “Archive”, “index”, “compression”, and “encryption” are examples of additional user-selectable file attributes.

Typically, if a user of a host device wants to use a file that is stored in a storage device, the host device checks the file protection policy associated with the file. For example, if the protection policy is defined by file attributes, it may check values of the file attributes related to the file, and allow the user to use the file only according to the value or state of the pertinent file attributes. That is, if the user attempts to perform an operation on the file which a file attribute does not allow, the host device refrains from performing the user operation. Therefore, the host device may be thought of as providing a protection layer between the user and the file. However, as the host device traditionally permits changes in the file attributes, the protection layer provided by the host device can be easily breached by the user voluntarily changing the value of file attribute, or by the host device operating with the storage device. The host device may inadvertently overwrite data that is part of, or related to, the file protection policy. If such data is overwritten, values of the file protection policy may change from ‘protection’ values to ‘non-protection’ values.

Another problem associated with file protection policies that involve using file attributes is that file attributes are traditionally held in the file system within the storage device. Storing file attributes in a file system is problematic because the host device can protect the values of file attributes only from applications that interact with the storage device through the file system. That is, if an application wants to write data in the storage device, the host device decides where to store it, and it will not overwrite the file attributes, as the storage locations of the file attributes is known to the host device from the file system. However, some management applications can write data directly to memory blocks within the storage device rather than through (i.e., using) the storage device's file system. This is problematic because the host device has no control regarding where in the storage device the file is written if the file system route is bypassed. Lacking such control makes the file attributes susceptible to storage operations that are performed by such applications.

There is therefore a need to address the problem of susceptibility of file attributes to applications that perform storage operations on a storage device. There is also a need to protect file attributes from being changed by unauthorized devices and users.

### SUMMARY

In view of the foregoing, it would be beneficial to be able to provide a mechanism for protecting file protection particulars in storage devices in order to enforce protection policies that are defined by such particulars. It would also be beneficial to protect the protection mechanism itself from unwanted changes. Various embodiments are designed to implement the protections, examples of which are provided herein.

To address the foregoing, a new file attribute, which is called herein “enforcement bit”, is used for each file that is stored in a storage device. If the protection particulars or properties (e.g., file attributes) associated with a file that is stored in the storage device are allowed to be changed (e.g., by a host device), the enforcement bit is set to a first value (e.g., “0” or “OFF”), and if the protection particulars or properties are not to be changed, the enforcement bit is set to a second value (e.g., “1” or “ON”). When the storage device is connected to a host device, the storage device provides to the host device protection particulars and an enforcement bit, which collectively form a “file protection policy”, for each stored file in response to a file system read command that the host device issues, in order to notify the host device of files in the storage device whose protection particulars are allowed to be changed freely (i.e., by each user and host device), and of files whose protection particulars are not allowed to be changed by unauthorized users or devices.

### BRIEF DESCRIPTION OF THE DRAWINGS

The accompanying drawings, which are incorporated in and constitute part of this specification, illustrate various embodiments with the intent that these examples not be restrictive. It will be appreciated that for simplicity and clarity of the illustration, elements shown in the figures referenced below are not necessarily drawn to scale. Also, where considered appropriate, reference numerals may be repeated among the figures to indicate like, corresponding or analogous elements. Of the accompanying figures:

FIG. 1 is a block diagram of a storage device according to an embodiment;

FIG. 2 shows the location of enforcement bits in a file system of a storage device according to an embodiment;

FIG. 3 shows a structure of a host command for setting enforcement bits in a storage device to “OFF”/“ON” according to an embodiment;

FIG. 4 shows a structure of a host command for protecting a file protection policy that is stored in a range of memory blocks within a storage device according to an embodiment;

FIG. 5 shows a structure of a host command for protecting indications (i.e., enforcement bits) that are stored in a range of memory bytes within a storage device according to an embodiment;

FIG. 6 is a method for updating a storage device with a file protection policy according to an embodiment;

FIG. 7 is a method for using a file protection policy by a host device according to an embodiment; and

FIG. 8 is a method for using a file protection policy by a host device according to another embodiment.

### DETAILED DESCRIPTION

The description that follows provides various details of exemplary embodiments. However, this description is not intended to limit the scope of the claims but instead to explain various principles of the invention and the manner of practicing it.

File attributes are mentioned throughout the disclosure as example of protection particulars. However, other protection particulars may be used. For example, protection-defining data can be stored in dedicated locations in the storage device rather than in dedicated locations within the file system.

As explained above, file protection policies which are handled by host devices are susceptible to inadvertent changes. A solution to this problem involves adding a second protection “layer” in the storage device, and notifying the host device with which the storage device operates, of the second protection layer and that the storage device is enforcing the second protection layer. If the new protection layer is added to a storage device and a host device with which the storage device operates is unable to enforce the file protection policy, or it ignores, misuses, or runs afoul of the file protection policy, the storage device enforces it.

The new protection layer can be implemented in various ways. For example, it may be implemented by adding and using a new file attribute, or a new indication, which is referred to herein as “enforcement bit”. The enforcement bit indicates to the storage device, and after sending the notification to the host device also to the host device, whether a file protection policy is to be enforced or not. If the file protection policy is not to be enforced, it means that changes in the file protection policy, whether by the host device or by the host device's user, are permitted.

The value of the enforcement bit is switchable (only) by a management entity between a first value or state (e.g., “0” or “OFF”) and a second value or state (e.g., “1” or “ON”). By using the first value (or by being in the first state), the storage device enforces the file protection policy; namely, it does not permit changes in the file protection policy. By using the second value (or by being in the second state), the storage device does not enforce the file protection policy; namely, it disregards the file protection policy and allows it to be changed.

By “enforced by the storage device” is meant that the storage device denies or ignores any attempt of an unauthorized device to change any property of the (enforced) file protection policy. There is one file protection policy and one enforcement bit for each file, and each enforcement bit may have one of the two values or states “OFF” and “ON”, depending on whether the pertinent file has to be protected or not. The values of the enforcement bits are set by a trusted party (e.g., management entity), readable by the host device but unchangeable by it or through it. The enforcement bits are stored in, and accessible through, a file system of the storage device in order to allow the host device to read them, and they are themselves protected in the storage device from unauthorized changes.

File Allocation Table (“FAT”) is a computer file system architecture that is widely used on many computer systems and on many memory cards. The FAT file system is supported by many operating systems, which makes it a useful format for memory cards and a convenient way to share data between operating systems. A FAT file system includes four different sections. The first section contains reserved sectors. The first reserved sector (sector 0) is the boot sector, which usually contains the operating system's boot loader code. The second section contains the FAT region. The FAT region typically contains two copies of the FAT for redundancy. The copies of the FAT are maps of the data region, and they indicate which memory clusters are used by files and directories. The third section contains the root directory region. The root directory region includes a directory table that stores information about files and directories that are located in the root directory. The root directory region is used only with FAT12 and FAT16. FAT32 stores the root directory in the data region, along with files and other directories. The fourth section contains the data region. The data region is a place where the actual file and directory data are stored. The size of files and subdirectories can be increased arbitrarily (as long as there are free memory clusters) by simply adding more links to the file's chain in the FAT. FAT32 typically holds the root directory table in cluster number 2, which is the first memory cluster of the data region.

A directory table is a special type of file that represents a directory. Each file or directory stored within a directory table in a FAT32 system is represented by a 32-byte entry in the table. Each table entry holds the name, extension, file attributes (“archive”, “directory”, “hidden”, “read-only”, “system” and “volume”), the date and time of creation, the address of the first cluster of the file/directory's data and finally the size of the file/directory. The twelfth byte in each directory entry includes eight bits that represent file attributes, as follows: bit 0 represents the “Read Only” attribute; bit 1 represents the “Hidden” attribute; bit 2 represents the “System” attribute; bit 3 represents the “Volume Label” attribute; bit 4 represents a “Subdirectory” attribute; bit 5 represents the “Archive” attribute; bit 6 represents a “Device” attribute (for internal use only); bit 7 is “Unused” bit. In one implementation, file attribute bit 6, which traditionally is not used, can be used as the enforcement bit. (Note: bit 7, another spare bit, can be used instead of bit 6.)

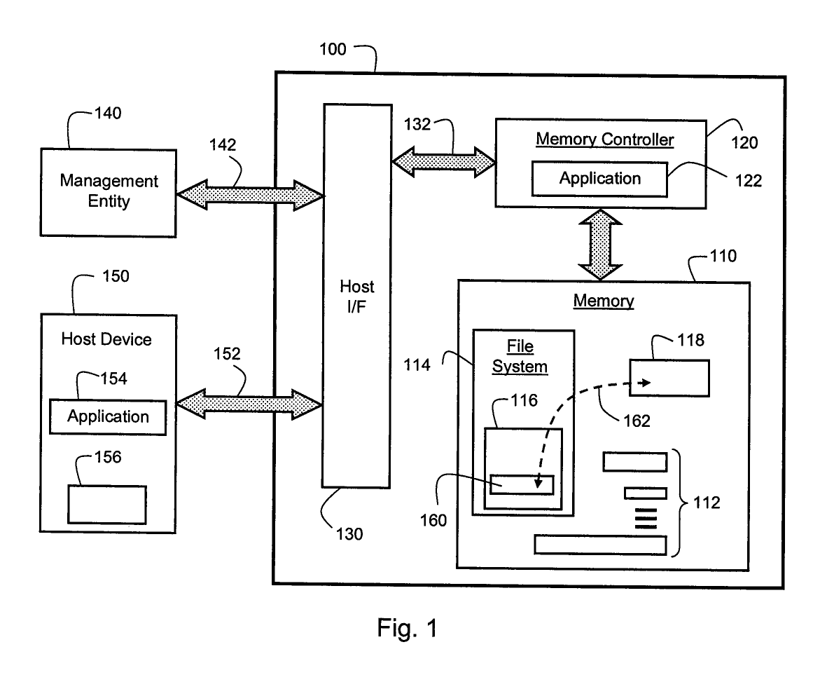

FIG. 1 is a block diagram of a storage device 100 according to an embodiment. Storage device 100 includes a memory 110 for storing files and a file system 114 of storage device 100 through which stored files are accessible.

Storage device 100 also includes a memory controller 120 for managing memory 110, and a host interface 130 for exchanging data/information and commands with management entity 140 and (not at the same time) with host device 150. Management entity 140 may be a service provider or a content provider, or the like. Host device 150 may be an application, a digital camera, a cellular phone, and the like. Management entity 140 sends 142 one or more files 112 to memory controller 120 through host interface 130, along with command(s) to store the files in memory 110. Management entity 140 also sends 142 a file protection policy to storage device 100, and memory controller 120 updates file system 114 with the file protection policy. Alternatively, management entity 140 writes file system 114 in memory controller 120 entirely, with the file protection policy already contained or embedded in it. The file protection policy, which is shown at 116, includes file protection particulars for each stored file, and possibly for files that are to be stored in memory 110. For example, file protection particulars 160 pertain to file 118 (the association of file protection particulars 160 to file 118 is shown by dashed line 162). That is, if file protection particulars 160 are used; namely, they are “turned on”, activated, or enabled, file 118 is protected by them, which means that file 118 can be accessed, used, or consumed only in the way specified by file protection particulars 160. If file protection particulars 160 are not used; namely, they are “turned off”, deactivated, or disabled, file 118 is not protected by them, which means that file 118 can be accessed, used, or consumed regardless of the specifics of file protection particulars 160. The content of file protection information 160 depends on the file protection policy, and it is predetermined by management entity 140, which can be an application or an external device.

Management entity 140 may determine that some of the files stored in memory 110 should be protected in the way specified in the pertinent file protection particulars, while other files should not be protected. Pursuant to the explanation above, regarding enabling and disabling of file protection particulars 160, the file protection policy of each file is either enabled or disabled by management entity 140, depending on which file should be protected and which file should not be protected.

In order to allow memory controller 120 to “know” whether a particular file protection policy associated with a particular file is to be enforced on the particular file, management entity 140 sets a corresponding value (e.g., “ON”) to an enforcement bit within file system 114, which is uniquely associated with the particular file protection policy and with the particular file. With the enforcement bit set to “ON”, memory controller 120 “knows” (i.e., the enforcement bit indicates) that it has to enforce the file protection policy on the file. If the enforcement bit is set to “OFF”, memory controller 120 knows that it should disregard the file protection policy. Changes to file protection policy 116 by non-managing entities (e.g., host device 150) are not permitted.

Management entity 140 sets file attributes of the files to specific states and thereafter stores the files and the related file attributes in memory 110. Trusted device 140 may additionally send a command to memory controller 120 to enforce the file attributes of a particular file and not to permit host 150, or the user of host device 150, to change any of them.

Memory controller 120 is, therefore, configured to receive 142 a command from management entity 140 to enforce file attributes of specific one or more files that are selected, for example, from files 112. In response to receiving one or more commands from management entity 140, memory controller 120 enforces file attributes of each selected file by switching the corresponding enforcement bit from “OFF” state, in which the pertinent file attributes are alterable by or through a host device (e.g., host device 150), to “ON” state, in which altering the pertinent file attributes by or through the host device is prohibited by memory controller 120.

Upon disconnecting storage device 100 from management entity 140 and interfacing storage device 100 with host device 150, memory controller 120 notifies 152 host device 150 of the files (e.g., one or more of files 112) whose file attributes are enforced by memory controller 120. Memory controller 120 notifies host device 150 of such files in order to prevent host device 150 from erroneously sending it false commands to change file attributes that are enforced by memory controller 120. File attributes that are enforced by memory controller 120 may be regarded as “protected file attributes”, as memory controller 120 does not permit changing them if a command to change them originates from untrusted devices (e.g., host device 150), as opposed to a change command originating from a trusted device such as management entity 140.

Upon connecting storage device 100 to host device 150, host device 150 reads file system 114 from storage device 100 in order to assume control of the file system. Reading file system 114 by host device 150 also means reading a directory table of file system 114 and the enforcement bits that reside in the directory table. The process in which memory controller 120 responds to the host's command to read file system 114 is regarded as notifying host device 150, by memory controller 120, of the file protection policies to be used, or notifying it of files whose file protection particulars (e.g., file attributes) are to be protected from changes. In other words, memory controller 120 notifies host device 150 of the files whose file attributes are protected by presenting a view of the entire directory table to host device 150 with some of the enforcement bits set to “OFF” and (probably) some enforcement bits set to “ON”, depending on which file's attributes are enforced/protected by memory controller 120 and which file's attributes are not. File protection particulars 160 may reside in the directory table. The viewed directory table is shown in host device 150 as directory table 156.

Regular file attributes are visible to the user of host device 150 in a traditional way. The enforcement bits are identifiable by host device 150 but are invisible to the user. Therefore, not knowing that a file attribute of a particular file is enforced by memory controller 120, the user may want to change its value or state, for example to change the state of a file attribute from “Read-Only”, which was selected by management entity 140 for protection, to “Read-Write”. However, host device 150 may be provided with means (e.g., software application 154) to identify the states of the enforcement bits and to react to them accordingly: to refrain from sending false commands to storage device 100 to change protected file attributes if the pertinent bit is set to “ON”, and (assuming the bit is set to “ON”) if such command is initiated by a user of the host device, to send a warning message to the user, for example “The file attribute cannot be changed!”. Application 112, when executed by memory controller 120, performs the process, procedures, determinations, etc. made by host device 150, as described herein.

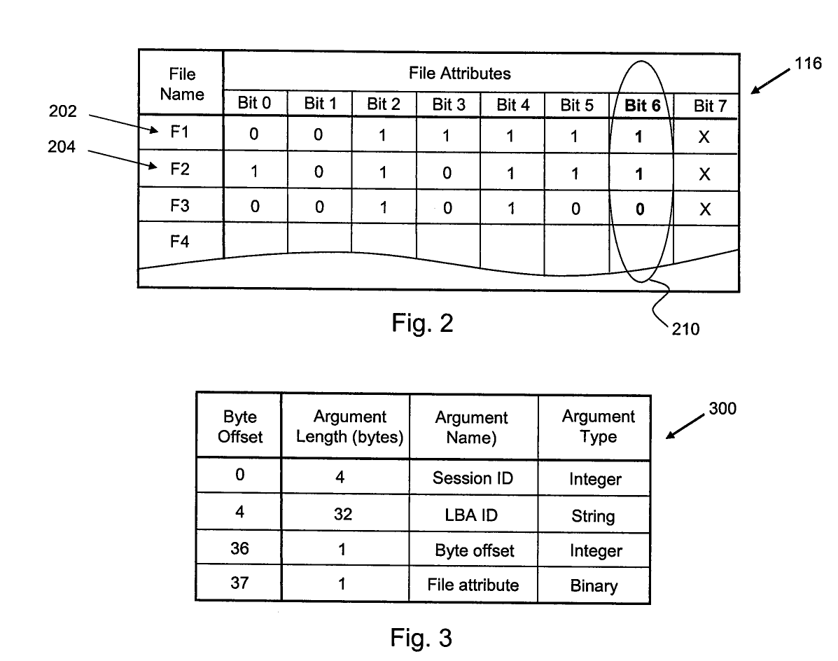

FIG. 2 shows a directory table 116 according to an embodiment. FIG. 2 will be described in association with FIG. 1. Directory table 116, which is part of a larger directory table, includes an entry for each file that is stored in memory 110, be it a user consumable/usable file (e.g., Microsoft WORD file, video file, music file, picture file, etc.), a system file, an application file, or a directory file through which a related file's data can be accessed (i.e., read, retrieved). Each entry in directory table 116 contains, among other things, the state of eight bits that are dedicated for the file attributes of the pertinent file. For example, directory table 116 includes an entry 202 for file “F1”, an entry 204 for file “F2”, an entry for file “F3”, etc. By way of example, bit 0 in entry 202, which conventionally represents the file attribute “Read Only”, is set to “0”, bit 1 (also in entry 202), which represents the file attribute “Hidden”, is set to “0”, bit 2 (also in entry 202), which represents the file attribute “System”, is set to “1”, and so on. Bit 0 through bit 5 are settable by the host or by the host's user, whereas bit 6 (shown at 210) is settable only by a trusted device such as management entity 140.

When memory controller 120 receives a command to protect the file attributes of a specific file, it complies with the command by setting the corresponding enforcement bit to “ON”. By way of example, bit 6 in the entry related to file “F1” (i.e., the enforcement bit of file “F1”) is set to “ON”, which, as explained above, means that neither the host device nor the host user are allowed to change the values of bit 0 through bit 5, inclusive, that are related to file “F1”. Likewise, bit 6 of the entry related to file “F2” (i.e., the enforcement bit of file “F2”) is set to “ON, which means that neither the host device nor the host user are allowed to change the value of bit 0 through bit 5, inclusive, that are related to file “F2”. Bit 6 of file “F3” is set to “0”, which means that the host device, or its user, are allowed to change the value of bit 0 through bit 5 that are related to file “F3”.

As explained above, memory controller 120 does not permit changes in file attributes if the related enforcement bit is set to “ON”. However, host device 150 may write legitimate data in memory 110 and, while such data is written, it may unintentionally overwrite one or more enforcement bits. Therefore, management entity 140 also sends a separate command to memory controller 120 to protect the enforcement bits from unwanted changes. FIG. 5, which is described below, shows an example command that a management entity may send to a storage device to protect the enforcement bits.

FIG. 3 shows an exemplary command 300 that a management entity sends to a storage device to set enforcement bits to “ON” according to an embodiment. Command 300 is an instruction for memory controller 120 to set a designated indication (i.e., enforcement bit) to “ON” or to “OFF”. A storage device may receive as many commands like command 300 as there are files in the storage device; i.e., one command for each file, or only commands that are required to set indications to “ON”, or only one command to set a group of indications to “ON”.

Command 300 includes a “session identifier” (“session ID”) field, which includes ID-related details pertaining to the communication session between management entity 140 and storage device 110, an “LBA ID” field, which includes the first logical block (LBA) address of an LBA memory block that contains the indication (i.e., enforcement bit), a “Byte offset” field which points to the byte within the pertinent LBA, which contains the indication, and a “File attribute” field, which indicates a value (e.g., “ON” or “OFF”) to which the indication should be set. By using command 300, the memory controller of the storage device (e.g., memory controller 120) identifies the memory location of the bit that serves as the “indication”, and sets the value of that bit to the designated value.

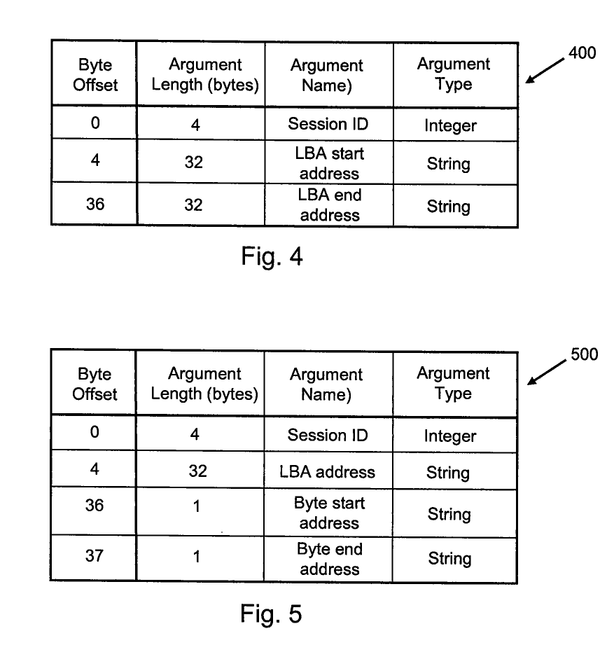

As explained herein, a file can be protected by using a file protection policy, and the file protection policy can be enforced by the storage device. However, the file protection policy and the indication of its enforcement by the storage device have to be protected as well in order to ensure that the file is protected as intended. Protecting the file protection policy and the indications is shown in FIG. 4 and FIG. 5, which are described below.

FIG. 4 shows an exemplary command 400 that a management entity sends to a storage device to protect a file protection policy that is stored in a range of LBAs according to an embodiment. Command 400 has a structure that includes a “session identifier” (“ID”) field that includes ID-related details pertaining to the communication session between the trusted device (e.g., management entity 140) and the storage device (e.g., storage device 110), and to a corresponding command for a memory controller of the storage device (e.g., memory controller 120) to protect a particular LBA range of memory blocks within the FAT's data region, that store the (particulars of the) file protection policy. To that end, the structure of command 400 also includes an “LBA start address” field and an “LBA end address” field that, respectively, specify to the storage device's memory controller the first LBA address and the last LBA address of the LBA range within the FAT's data region. By using command 400, the memory controller of the storage device (e.g., memory controller 120) protects file protection policies from unauthorized changes. If a file protection policy is stored in interspersed LBA addresses (i.e., not in contiguous LBA addresses), management entity 140 may send a command similar to command 400 to the storage device for (i.e., to protect) each LBA address.

In one implementation, command 400 only specifies the addresses of the memory blocks that store the file protection policy, and the memory controller protects the content of these memory blocks (i.e., the policy's particulars) or refrains from protecting it depending on the value of the corresponding indication bit. Alternatively, command 400 also instructs the memory controller to protect the content of the specified memory blocks regardless of the value of that bit. Protecting the file protection policy also includes protecting the pertinent indication by protecting a memory byte within the memory that holds the indication.

Returning to FIG. 2, directory table 116 is shown containing only attribute bits. However, each entry in directory table 116 also contains directory data that facilitate access to files. (Note: depending on the FAT scheme, the directory data may be stored in the FAT's root directory region or in the FAT's data region.) Depending on the directory specifics of the directory path of a file, the file may be accessed through one or more directories, where each directory has a separate directory table/file associated with it. (Note: if there are two or more directories involved in accessing a file, the first directory is referred to as “root directory” and the other directories are referred to as “subdirectories”.) If several directory tables are needed to access a particular file, the root directory of that file contains a pointer that points to the first subdirectory table; the first subdirectory table contains a pointer that points to the second subdirectory table, and so on, and the last subdirectory table contains a pointer that points to the first memory address of the file's data.

If, for some reason, the genuine directory path of a protected file is changed or deleted, the file cannot be accessed even if the file's data and attributes are protected. Therefore, there is no point in using a file protection policy to protect a file if the file is “invisible” through the file system because its directory path is corrupted. Therefore, management entity 140 may also use command 400, or a similar command, to protect the directory data (i.e., directory path) associated with the protected file in order to protect the genuine directory path of the protected file. Management entity 140 may also use a command such as command 400 to protect an entire 32-byte (for example) entry in the directory table, which pertains to a protected file.

FIG. 5 shows an exemplarity command that a management entity may send to a storage device to protect enforcement bits according to an embodiment. Command 500 has a structure that include a “session identifier” (“ID”) field, which includes ID-related details pertaining to the communication session between the trusted device (e.g., management entity 140) and the storage device (e.g., storage device 110) and to a corresponding command to protect the content of the bits that store (i.e., serve as) the indications. The structure of command 500 also includes an “LBA address” field that specifies (i.e., to the memory controller of the storage device) the LBA address that includes the enforcement bits that need to be protected, a “byte start address”, which specifies the first byte within the specified LBA address that needs to be protected, and a “byte end address”, which specifies the last byte within the LBA address that needs to be protected. A protected byte may include only one indication bit or more then one indication bit. By using command 500, the memory controller of the storage device (e.g., memory controller 120) protects the indications from unauthorized changes.

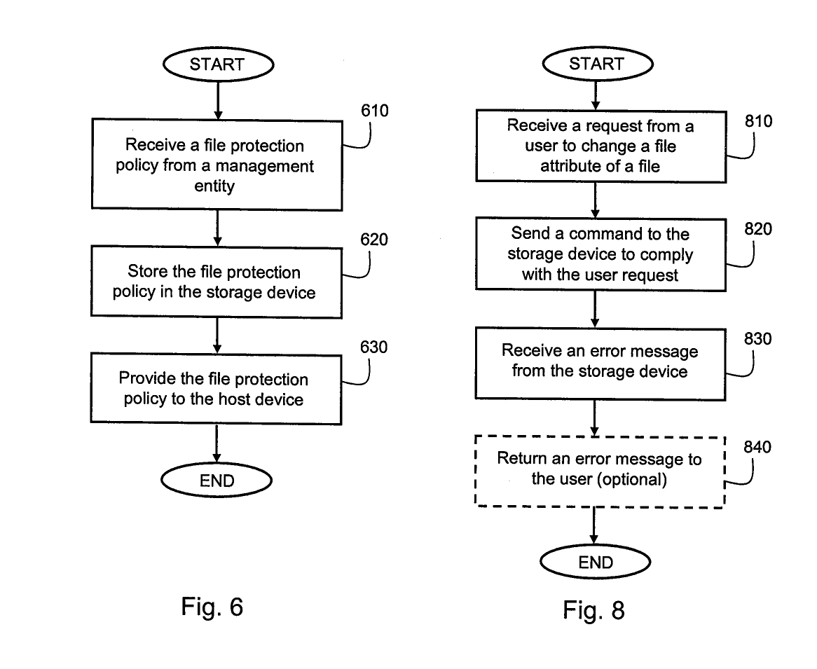

FIG. 6 is a method for protecting a file protection policy according to an embodiment. FIG. 6 will be described in association with FIG. 1. At step 610, storage device 100 receives from management entity 140 a file protection policy to protect one or more files that are stored in memory 110 (and probably for one or more files that are to be stored in memory 110. The file protection policy may include protection particulars, or it may define protection properties, that are to be applied to selected files. The file protection policy may also include enforcement bits whose values/states indicate whether the protection particulars, or protection properties, pertaining to each selected file are to be enforced or not.

The protection particulars, or the define protection properties, may be transferred to storage device 100 as a protection policy file. The protection policy file may be stored in memory 110 as is, or the content of the protection policy file may be stored, or embedded, within the file system of storage device 100.

The enforcement bits may be transferred to storage device 100 using one of the methods: (1) if storage device 100 includes a file system with enforcement bits set to irrelevant values or states, storage device 100 may receive the file protection policy as one or more commands to set the enforcement bits of interest within the file system to “ON”; (2) if storage device 100 includes a file system that does not contain enforcement bits, it may receive a replacement file system that includes enforcement bits that are preset (e.g., by management entity 140) to the relevant values or states; and (3) if storage device 100 does not include a file system, it may receive a file system that includes enforcement bits, with the enforcement bits being preset to the relevant values or states.

Depending on the method used to transfer the file protection policy to storage device 100, at step 620 memory controller 120 executes the commands to set the enforcement bits within the file system to the correct values or states, or to write (i.e., store) the file system, with the enforcement bits set to the correct values or states, into memory 110.

At step 630, memory controller 120 provides the file protection policy to host device 150 in response to the host device sending a read command to the storage device to read the file system of the storage device. By providing the file protection policy to the host device memory controller 120 notifies the host device of the file protection policy and that the file protection policy is enforced by storage device 100. If the host device “understands” the meaning of the file protection policy and complies with it, it does not attempt to send storage commands to storage device 100 that breach the file protection policy. If the host device does not understand the meaning of the file protection policy, it may attempt to send illegal storage commands to storage device 100. However, in the second case memory controller 120 refrains from executing the host's command in order not to breach the file protection policy. By “understands the meaning of the file protection policy” is meant understanding that if an enforcement bit is set to “ON”, this means that the protection particulars or properties pertaining to an associated file that is stored in memory 100 are not to be changed, and that an attempt to change any protection particular or property will fail; i.e., it will be denied or ignored.

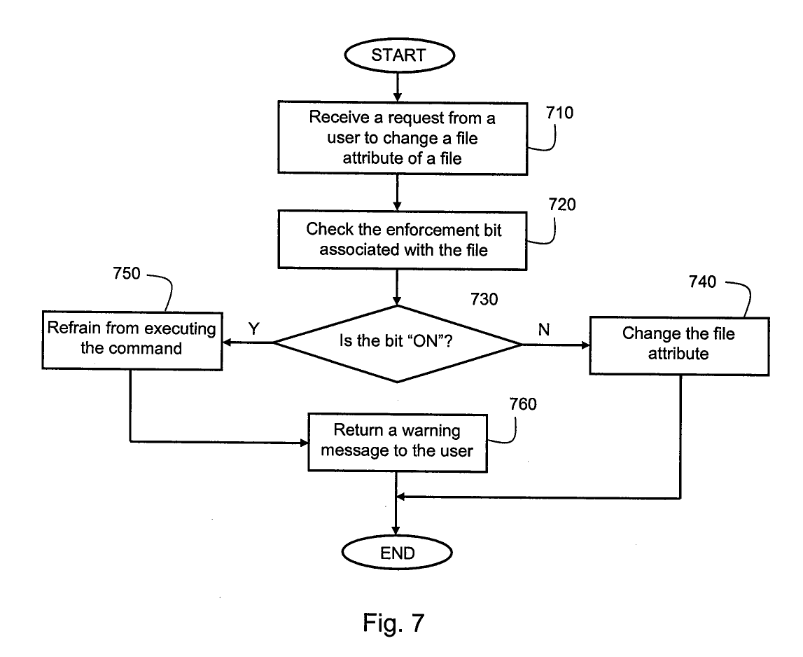

A host device may be a ‘file protection policy compliant’ device, or a non-compliant device. A an example method for using a file protection policy if the host device is a file protection policy compliant is shown in FIG. 7, which is described below. A an example method for using a file protection policy if the host device is a non-compliant device is shown in FIG. 8, which is also described below.

FIG. 7 is an example method of using a file protection policy according to an embodiment. FIG. 7 will be described in association with FIG. 1. Assume that storage device 100 is connected to host device 150 and a user wants to change the current state of a protection particular that in this example is a file attribute (e.g., “Read-Only”) of a particular file ‘x’ that is stored in memory 110. At step 710, host device 150 receives a request from a user to change the state of a particular file attribute of a particular file.

At step 720, host device 150 checks the enforcement bit associated with the file. If the enforcement bit is “OFF” (shown as “N” at step 730), which means that any device is allowed to change the state of the pertinent file attribute, host device 150 changes, at step 740, the state of the file attribute by sending a corresponding command to memory controller 120. If the enforcement bit is “ON” (shown as “Y” at step 730), host device 150 refrains, at step 750, from any action that would result in a change in the file attribute. At step 760, host device 150 returns a warning message to the user, for example “The file attributes of file ‘x’ are unchangeable”.

As explained above, steps 710 through 760, inclusive, as described above, refer to cases where the host device can interpret enforcement bits and act accordingly. However, conventional host devices are incapable of understanding the meaning of enforcement bits because enforcement bits occupy conventionally unused bits in the associated directory table.

FIG. 8 is an example method of using a file protection policy according to an embodiment. FIG. 8 will be described in association with FIG. 1. Assume that storage device 100 is connected to host device 150 and a user wants to change the current state of a protection particular that in this example is a file attribute (e.g., “Read-Only”) of file ‘x’ that is stored in memory 110. At step 810, host device 150 receives a request from a user to change the state of the particular file attribute of a particular file. At step 820, host device 150 sends a command to storage device 100 to change the state of the file attribute. That is, if host device 150 receives a user request to change the file attribute and host device 150 is not configured to respond to enforcement bits, host device 150 sends, at step 820, a command to memory controller 120 to change the file attribute regardless of the state of the pertinent enforcement bit. As explained above, if memory controller 120 receives a command from host device 150 to change a protection particular, it checks the state of the enforcement bit related to the protection particular and if it is “ON” it denies the command and sends en error message to host device 150.

At step 830, host device 150 receives the error message from memory controller 120 regarding the denied request. Depending on the capabilities of host device 150, host device 150 may respond to the error message it receives from memory controller 120 by returning to the user an error message, at step 840. Host device 150 may alternatively ignore the error message sent from memory controller 120.

Memory controller 120 can be a standard off-the-shelf System-on-Chip (“SoC”) device or a System-in-Package (“SiP”) device or general purpose processing unit with specialized software or application (e.g., application 122) that, when executed by memory controller 120, performs the configurations, steps, operations, determinations and evaluations described herein. Alternatively, memory controller 120 can be an Application-Specific Integrated Circuit (“ASIC”) that implements the configurations, steps, operations, determination and evaluations described herein by using hardware.

The articles “a” and “an” are used herein to refer to one or to more than one (i.e., to at least one) of the grammatical object of the article, depending on the context. By way of example, depending on the context, “an element” can mean one element or more than one element. The term “including” is used herein to mean, and is used interchangeably with, the phrase “including but not limited to”. The terms “or” and “and” are used herein to mean, and are used interchangeably with, the term “and/or,” unless context clearly indicates otherwise. The term “such as” is used herein to mean, and is used interchangeably, with the phrase “such as but not limited to”.

Note that the foregoing is relevant to various types of mass storage devices such as memory cards, SD-driven flash memory cards, flash storage devices, “Disk-on-Key” devices that are provided with a Universal Serial Bus (“USB”) interface, USB Flash Drives (““UFDs”), MultiMedia Card (“MMC”), Secure Digital (“SD”), miniSD and microSD, and so on.

Having thus described exemplary embodiments of the invention, it will be apparent to those skilled in the art that modifications of the disclosed embodiments will be within the scope of the invention. Alternative embodiments may therefore include more modules, fewer modules and/or functionally equivalent modules. Hence the scope of the claims that follow is not limited by the disclosure herein.

What is claimed is:

1. A method of enforcing a file protection policy by a storage device, the method comprising:
in a storage device connected to a host device, the storage device including a memory and a memory controller for managing the memory, the memory storing a file system that contains a file protection policy for protecting a file stored in the memory, performing by the memory controller,
providing the file protection policy to enable the host device to comply with the file protection policy; and
protecting the file protection policy within the file system from changes.

2. The method as in claim 1, further comprising enforcing the file protection policy by:
executing a storage operation command originating from the host device only if the storage operation command complies with the file protection policy.

3. The method as in claim 1, wherein providing the file protection policy includes providing an indication that the file protection policy is enforced by the storage device.

4. The method as in claim 3, wherein the indication that the file protection policy is enforced by the storage device is included within the file system on the storage device.

5. The method as in claim 3, wherein the indication is a bit for each file in the file system on the storage device, and wherein each bit is set to “ON” or “OFF” state depending on whether the file protection policy is being enforced or not for the file corresponding to that bit.

6. The method as in claim 3, wherein protecting the file protection policy includes protecting a memory byte within the memory that holds the indication.

7. The method as in claim 3, wherein the file protection policy is defined by file attributes related to the file.

8. The method as in claim 7, further comprising preventing the host device from changing a value of the file attributes.

9. The method as in claim 8, further comprising refraining from changing the value of the file attributes if the indication is set to “ON”.

10. The method as in claim 9, wherein the file attributes are “read-only”, “archive”, “system file”, “hidden”, “volume label”, and “subdirectory”.

11. The method as in claim 1, wherein the file protection policy is received from a management entity.

12. The method as in claim 11, further comprising authenticating the management entity before receiving the file protection policy.

13. The method as in claim 1, further comprising:
receiving a command to protect, from a writing operation, a memory block within the memory that holds any one of the file or a portion thereof, an entry in a directory table which pertains to the file, and directory data or part thereof that pertains to a directory path of the file.

14. The method as in claim 1, wherein the file system is a file allocation table (FAT) containing a directory table with an entry for each file stored in the memory, where each entry contains a file protection policy for the pertinent file and an indication for the host device that the file protection policy is enforced by the storage device.

15. A storage device comprising:
a memory for storing a file system that contains a file protection policy for protecting a file stored in the memory,
a memory controller for managing the memory, wherein the memory controller is configured,
to provide the file protection policy to enable a host device to comply with the file protection policy; and
to protect the file protection policy within the file system from changes.

16. The storage device as in claim 15, wherein the memory controller is further configured to enforce the file protection policy by executing a storage operation command originating from the host device only if the storage operation command complies with the file protection policy.

17. The storage device as in claim 15, wherein the memory controller provides to the file protection policy an indication that the file protection policy is enforced by the storage device.

18. The storage device as in claim 17, wherein the memory controller includes the indication that the file protection policy is enforced by the storage device within the file system on the storage device.

19. The storage device as in claim 17, wherein the indication is a bit for each file in the file system on the storage device, and wherein the memory controller sets each bit set to “ON” or “OFF” state depending on whether the file protection policy is being enforced or not for the file corresponding to that bit.

20. The storage device as in claim 17, wherein the memory controller protects the file protection policy by protecting a memory byte within the memory that holds the indication.

21. The storage device as in claim 17, wherein the file protection policy is defined by file attributes related to the file.

22. The storage device as in claim 21, wherein the file attributes are “read-only”, “archive”, “system file”, “hidden”, “volume label”, and “subdirectory”.

23. The storage device as in claim 21, wherein the memory controller is configured to prevent the host device from changing a value of the file attributes.

24. The storage device as in claim 21 wherein the memory controller is configured to refrain from changing the value of the file attributes if the indication is set to the “ON” state.

25. The storage device as in claim 15, wherein the memory controller receives the file protection policy from a management entity.

26. The storage device as in claim 25, wherein the memory controller authenticates the management entity before it receives the file protection policy.

27. The storage device as in claim 15, wherein the memory controller is configured to receive a command to protect, from a writing operation, a memory block within the memory that holds the file or a portion thereof, or an entry in a directory table which pertains to the file, or directory data or part thereof that pertains to the directory path of the file.

28. The storage device as in claim 15, wherein the file system is a file allocation table (FAT) containing a directory table with an entry for each file stored in the memory, where each entry contains a file protection policy for the pertinent file and an indication for the host device that the file protection policy is enforced by the storage device.
